(19) United States
(12) Patent Application Publication
(10) Pub. No.: US 2017/0116066 A1
(43) Pub. Date: Apr. 27, 2017

(54) FAULT DETECTING SYSTEM AND METHOD FOR SERVER

(71) Applicants: HONGFUJIN PRECISION ELECTRONICS (TIANJIN) CO., LTD, Tianjin (CN); HON HAI PRECISON INDUSTRY CO., LTD., New Taipei (TW)

(72) Inventors: DUO QIU, Shenzhen (CN); YU-JIE MA, Shenzhen (CN)

(73) Assignees: HON HAI PRECISION INDUSTRY CO., LTD., New Taipei (TW); HONGFUJIN PRECISION ELECTRONICS (TIANJIN) CO.,LTD., Tianjin (CN)

(21) Appl. No.: 14/928,577

(22) Filed: Oct. 30, 2015

(30) Foreign Application Priority Data
Oct. 21, 2015 (CN) 201510693066.8

(51) Int. Cl. G06F 11/07

(52) U.S. Cl. CPC G06F 11/0772; G06F 11/0706; G06F 11/0751; G06F 11/079

(57) ABSTRACT

A fault detecting system for a server includes a field programmable gate array (FPGA) unit and an user interface. The FPGA unit is configured to detect at least one fault signal of the server, and to output fault signal in form of logic level. The user interface includes a processing unit and a display. The processing unit is configured to receive the fault signal in form of logic level, and to determine whether the logic level of the fault signal is changed. In event the logic level of the fault signal is changed, the processing unit output a fault message to the display. Therefore, user can be prompted a position of the fault of server through the display.

### FIELD

The subject matter herein generally relates to a fault detecting system and method for a server.

### BACKGROUND

A server usually depends on baseboard management controller (BMC) to detect fault of a plurality of elements, which cannot detect the fault of the plurality of elements normally.

### BRIEF DESCRIPTION OF THE DRAWINGS

Implementations of the present technology will now be described, by way of example only, with reference to the attached figures.

FIG. 1 is a diagrammatic view of one embodiment of a fault detecting system for a server, wherein the server comprises a field programmable gate array (FPGA) unit and an user interface.

FIG. 2 is a block diagram of one embodiment of the user interface of the fault detecting system.

FIG. 3 is a flow chart of one embodiment of at least one fault signal detected by the FPGA unit and transmitted from the FPGA unit to the user interface.

FIGS. 4 and 5 are a flow chart of one embodiment of processing the fault signal by the user interface.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

The disclosure will now be described in relation to a fault detecting system and method.

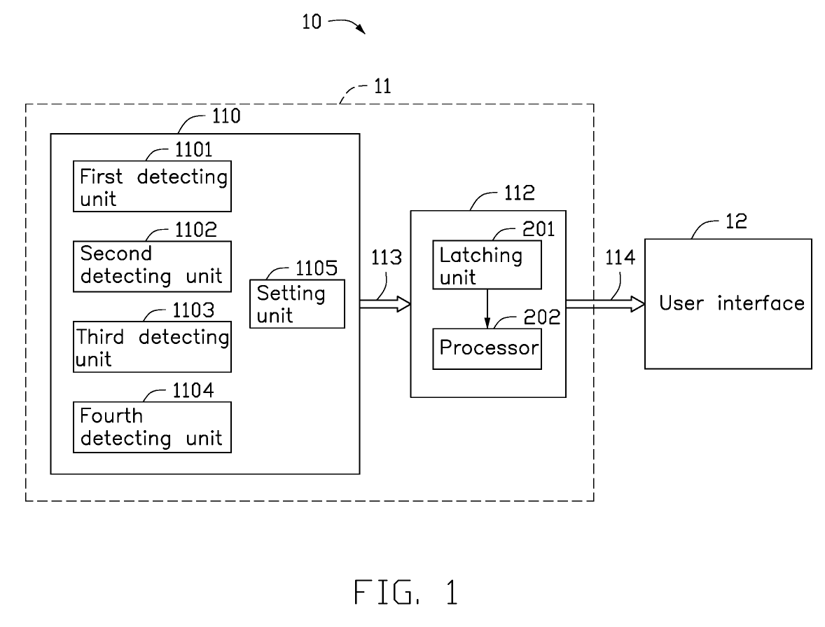

FIG. 1 illustrates diagrammatic view of one embodiment of a fault detecting system 10 for a server.

The fault detecting system 10 can include, but not limited to, a field programmable gate array (FPGA) unit 11 and an user interface 12. The FPGA unit 11 includes a fault detecting unit 110 and a register transfer level (RTL) circuit 112.

The RTL circuit 112 includes a latching unit 201 and a processor 202. The fault detecting unit 110 is electrically coupled to the latching unit 201 through a first serial port connector 113. The processor 202 is electrically coupled to the user interface through a second serial port connector 114. In at least one embodiment, the first serial port connector 113 and the second serial port connector 114 are serial buses RS232.

In at least one embodiment, the fault detecting unit 110 can include, but not limited to, a first detecting unit 1101, a second detecting unit 1102, a third detecting unit 1103, a fourth detecting unit 1104, and a setting unit 1105. The first detecting unit 1101 is configured to detect whether at least one electronic components, such as processor, storage, and chipset of the server are failure. The second detecting unit 1102 is configured to detect whether at least one fuses of the server are failure. The third detecting unit 1103 is configured to detect whether at least one power supplies of the server are failure. The fourth detecting unit 1104 is configured to detect whether at least one regulators of the server are failure. Each of the detecting units can detect at least one fault of the corresponding electronic components, and output corresponding fault signal in form of logic level. The setting unit 1105 is configured to receive the logic level of the fault signals of the first to fourth detecting unit, and to set the logic level of the fault signal to a failure state value, such as logic “0”.

The latching unit 201 is configured to receive the failure state value from the fault detecting unit 110, to keep the failure state value in one level state. The processor 202 is a soft micro processor of a reduced instruction set computer (RISC). In at least one embodiment, the processor 202 is a chip of LatticeMico32. The processor 202 is electrically coupled to the latching unit 201 through a plurality general purpose input/output (GPIO) interfaces, and is configured to receive the failure state value output from the latching unit 201. The processor 202 is configured to transmit the logic level of the failure state value to the user interface 12 through the serial port connector 114.

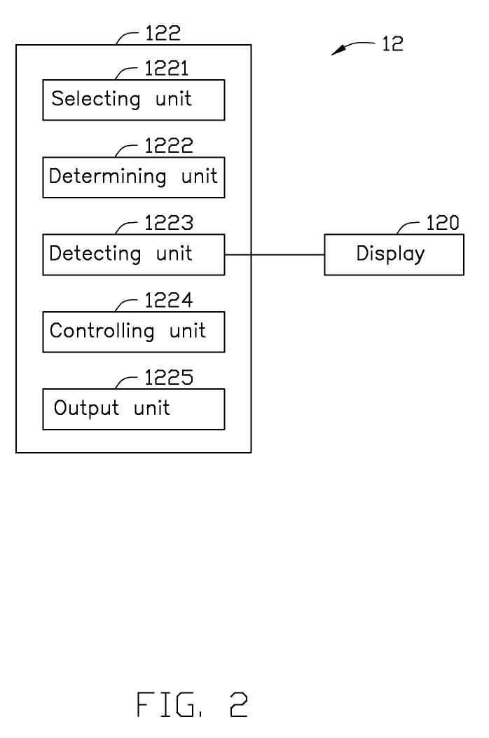

FIG. 2 illustrates a block diagram of one embodiment of the user interface 12 of the fault detecting system 10. The user interface 12 includes a display 120 and a processing unit 122. The processing unit 122 includes a selection unit 1221, a determining unit 1222, a detecting unit 1223, a controlling unit 1224, and an output unit 1225. The selecting unit 1221 is configured to select a serial port detected of the user interface 12, to receive the logic level of the failure state value from the FPGA unit 11. The determining unit 1222 is configured to determine whether the serial port is selected successfully. The selection unit 1221 is configured to select an appropriate baud rate of the signal transmitted through the serial port of the user interface, to set a speed of the signal transmitted through the serial port. The determining unit 1222 is configured to determine whether the serial port selected exists a corresponding serial port cable. If the corresponding serial port cable is not existing, the controlling unit 1224 controls the output unit 1225 to output a serial port initialization message, and prompt the user whether continuing to continue to carry on the operation. If the user selects continuing to carry on the operation, the controlling unit 1224 cleans data of the serial port of the user interface 12, and scans the data once more of the serial port. The detecting unit 1223 is configured to detect a starting address and a ending address of the fault signal transmitted from the FPGA unit 11, to acquire a data section detected of the fault signal according to the starting address and the ending address, and detects a data margin state of the fault signal. The determining unit 1222 can also determine whether the data margin state of the fault signal exists a logic high level, such as “1”. If the logic high level exists in the data section detected, the output unit 1225 outputs a fault prompting message to the display 120. The determining unit 1222 can also determine whether the detection of the data margin state of the fault signal has been finished. Therefore, the output unit 1225 can output a fault message to the display 120, to prompt a position of the fault occurring.

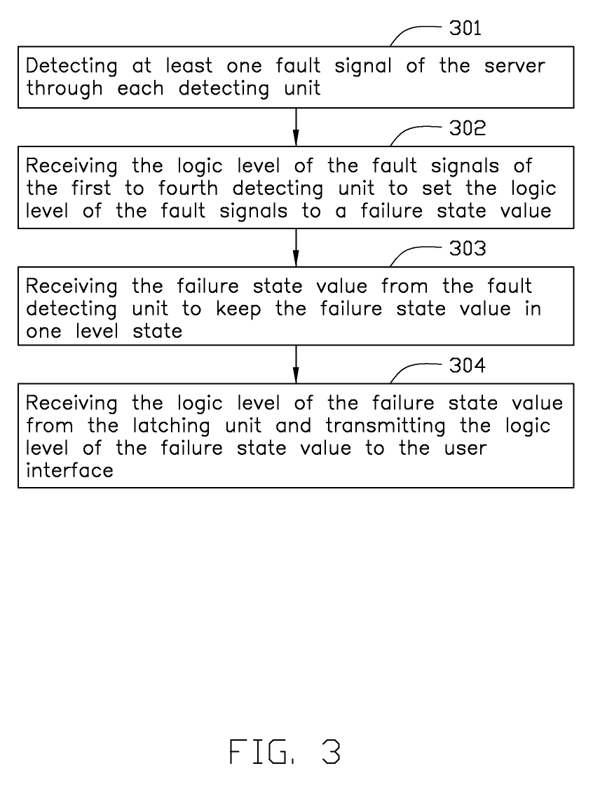

Referring to FIG. 3, flowcharts are presented in accordance with an example embodiment of an pedestrian detection system which are being thus illustrated. The example method is provided by way of example, as there are a variety of ways to carry out the method. The method described below can be carried out using the configurations illustrated in FIG. 1, for example, and various elements of the figure is referenced in explaining example method. Each block shown in FIG. 3 represents one or more processes, methods or subroutines, carried out in the exemplary method. Furthermore, the illustrated order of blocks is by example only and the order or fewer blocks may be utilized, without departing from this disclosure. The exemplary method can be executed by fault detecting system 10, and can begin at block 301.

At block 301, the fault detecting system 10 detects at least one fault signal of server through each detecting unit, and outputs corresponding fault signals in form of logic level.

At block 302, the setting unit 1105 receives the logic level of the fault signals of the first to fourth detecting unit, and sets the logic level of the fault signals to a failure state value, such as logic “0”.

At block 303, the latching unit 201 receives the failure state value from the fault detecting unit 110, to keep the failure state value in one level state.

At block 304, the processor 202 receives the logic level of the failure state value from the latching unit 201 through a plurality general purpose input/output (GPIO) interfaces, and transmit the logic level of the failure state value to the user interface 12 through the serial port connector 114. In at least one embodiment, the processor 202 is a chip of LatticeMico32.

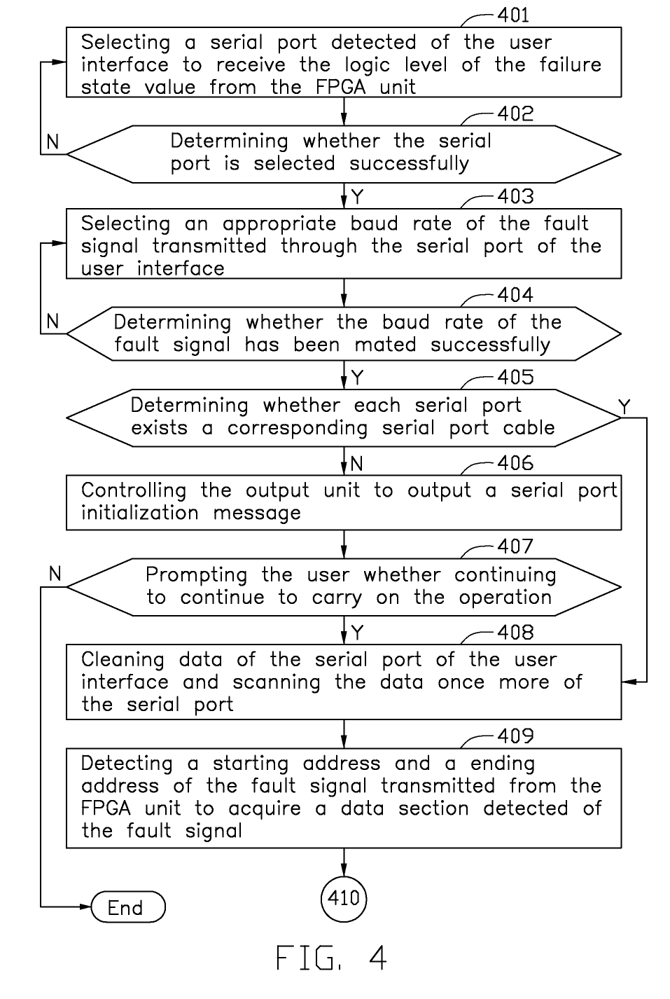

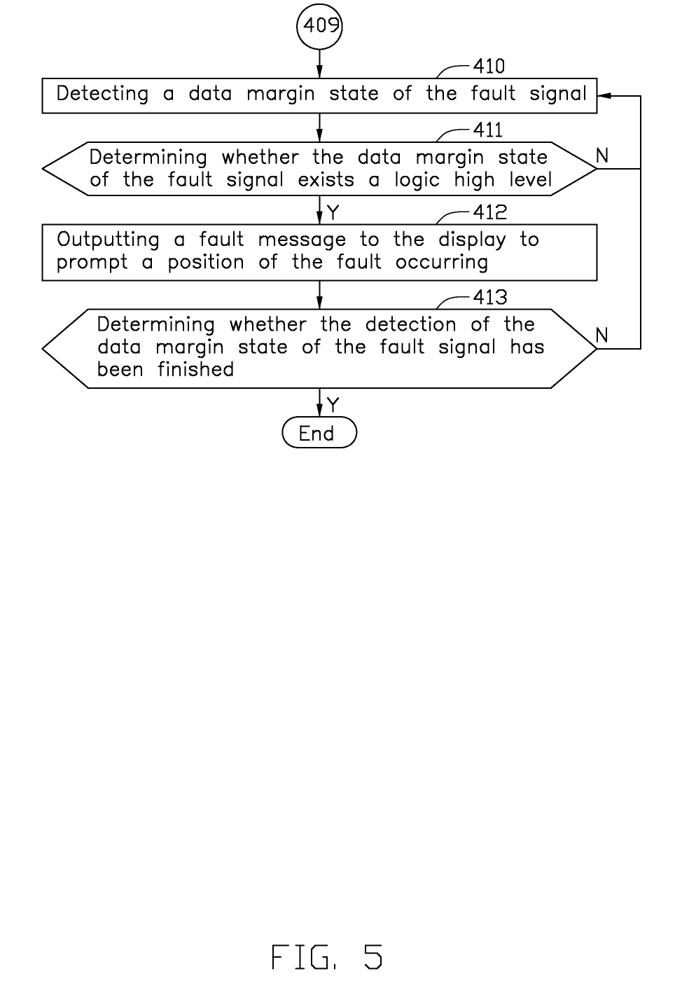

Referring to FIGS. 4 and 5, a flow chart of one embodiment of processing the fault from the FPGA unit 11 by the user interface 12, which is beginning at block 401.

At block 401, the selecting unit 1221 selects a serial port detected of the user interface 12, to receive the logic level of the failure state value from the FPGA unit 11.

At block 402, the determining unit 1222 determines whether the serial port is selected successfully, if the serial port has not been selected, the process goes to block 401; otherwise, the process goes to block 403.

At block 403, the selection unit 1221 selects an appropriate baud rate of the fault signal transmitted through the serial port of the user interface, and transmits the fault signal to the determining unit 1222.

At block 404, the determining unit 1222 determines whether the baud rate of the fault signal has been mated successfully, if not, the process goes to 403; otherwise, the process goes to 405.

At block 405, the determining unit 1222 determines whether each serial port exists a corresponding serial port cable, if not, the process goes to block 406; otherwise, the process goes to block 408.

At block 406, the controlling unit 1224 controls the output unit 1225 to output a serial port initialization message.

At block 407, the output unit 1225 outputs a prompting message to prompt the user whether continuing to continue to carry on the operation, if not, the process goes to end; otherwise, the process goes to 408.

At block 408, the controlling unit 1224 cleans data of the serial port of the user interface 12, and scans the data once more of the serial port.

At block 409, the detecting unit 1223 detects a starting address and an ending address of the fault signal transmitted from the FPGA unit 11, to acquire a data section detected of the fault signal according to the starting address and the ending address.

At block 410, the detecting unit 1223 detects a data margin state of the fault signal. In at least one embodiment, the data margin state is a logic level of the margin of the fault signal detected.

At block 411, the determining unit 1222 determines whether the data margin state of the fault signal exists a logic high level, such as “1”. If the logic high level exists in the data section detected, the process goes to 412; otherwise goes to 410.

At block 412, the output unit 1225 outputs a fault message to the display 120, to prompt a position of the fault occurring.

At block 413, the determining unit 1222 determines whether the detection of the data margin state of the fault signal has been finished.

While the disclosure has been described by way of example and in terms of the embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A fault detecting system for a server comprising:
a field programmable gate array (FPGA) unit configured to detect at least one fault signal of the server and to output fault signal in form of logic level; and
an user interface comprising:
a processing unit configured to receive the fault signal in form of logic level and to determine whether the logic level of the fault signal is changed; and
a display electrically coupled to the processing unit,
wherein in event the logic level of the fault signal is changed, the processing unit output a fault message to the display.

2. The fault detecting system according to claim 1, wherein the processing unit comprises a selecting unit configured to select a serial port transmitting data of fault signal, to receive the logic level of the fault signal.

3. The fault detecting system according to claim 2, wherein selecting unit is configured to select baud rate of the fault signal transmitted through the serial port of the user interface.

4. The fault detecting system according to claim 3, wherein the processing unit comprises a detecting unit configured to detect a starting address and an ending address of the fault signal, to determine a data section detected of the fault signal.

5. The fault detecting system according to claim 4, wherein the processing unit comprises a determining unit configured to determine whether the data margin state of the fault signal is changed.

6. The fault detecting system according to claim 5, wherein the FPGA unit comprises a detecting unit and a setting unit, the detecting unit is configured to determine different types of the fault of the server, the setting unit is configured to set the logic level of the fault signal to a failure state value.

7. The fault detecting system according to claim 6, wherein FPGA unit comprises a latching unit configured to receive the failure state value from the fault detecting unit, to keep the failure state value in one level state.

8. A fault detecting method for a server comprising:
detecting at least one fault signal of server;
outputting the fault signal in form of logic level;
determining the whether the logic level of the fault signal is changed;
outputting a prompting message if the logic level of the fault signal is changed.

9. The fault detecting method according to claim 8, further comprising a process that setting the logic level of the fault signal to a failure state value, which is after outputting the fault signal in form of logic.

10. The fault detecting method according to claim 9, further comprising a process that determining the whether the logic level of the fault signal is changed according to the failure state value.
